(19) United States
(12) Patent Application Publication
(10) Pub. No.: US 2026/0056696 A1
(43) Pub. Date: Feb. 26, 2026

(54) EXCLUDING CONTENT DURING SCREENSHARING SESSION

(71) Applicant: Google LLC, Mountain View, CA (US)

(72) Inventor: Xiaohan Wang, Redmond, WA (US)

(21) Appl. No.: 18/809,860

(22) Filed: Aug. 20, 2024

(51) Int. Cl. G06F 3/14; G06F 16/957

(52) U.S. Cl. CPC G06F 3/1454; G06F 16/9577

(57) ABSTRACT

A method performed by a computing device comprises, during a screensharing session, determining a capture value of a first element and a capture value of a second element, wherein the capture value of the first element is determined by a provider and the capture value of the second element is determined by the provider, the provider having provided the first element to the computing device and having provided the second element to the computing device; based on the capture value of the first element being shareable, sending content of the first element to the screensharing session; and based on the capture value of the second element being not sharable, excluding content of the second element from the screensharing session.

### BACKGROUND

A user may share content displayed on a computing device associated with the user during a screensharing session. However, some of the content may contain information that may potentially be harmful to share.

### SUMMARY

During a screensharing session, a computing system determines whether content should be shared. The computing system can determine whether content should be shared on an element-by-element basis. The computing system can determine capture values of the elements. For an element that has a capture value of shareable, the computing system can send content of the element to a screensharing session. For an element that has a capture value of not shareable, the computing system can exclude content of the element from the screensharing session. The capture value of an element can be determined by a content owner (or provider) to prevent unintentional or accidental disclosure of sensitive content to other users.

According to an example, a method performed by a computing device comprises, during a screensharing session, determining a capture value of a first element and a capture value of a second element, wherein the capture value of the first element is determined by a provider and the capture value of the second element is determined by the provider, the provider having provided the first element to the computing device and having provided the second element to the computing device; based on the capture value of the first element being shareable, sending content of the first element to the screensharing session; and based on the capture value of the second element being not sharable, excluding content of the second element from the screensharing session.

According to an example, a non-transitory computer-readable medium comprising instructions stored thereon. When executed by at least one processor, the instructions are configured to cause a computing device to, during a screensharing session, determine a capture value of a first element and a capture value of a second element, wherein the capture value of the first element is determined by a provider and the capture value of the second element is determined by the provider, the provider having provided the first element to the computing device and having provided the second element to the computing device; based on the capture value of the first element being shareable, send content of the first element to the screensharing session; and based on the capture value of the second element being not sharable, exclude content of the second element from the screensharing session.

A computing device comprises at least one processor and a non-transitory computer-readable medium comprising instructions stored thereon. When executed by the at least one processor, the instructions are configured to cause the computing device to, during a screensharing session, determine a capture value of a first element and a capture value of a second element, wherein the capture value of the first element is determined by a provider and the capture value of the second element is determined by the provider, the provider having provided the first element to the computing device and having provided the second element to the computing device; based on the capture value of the first element being shareable, send content of the first element to the screensharing session; and based on the capture value of the second element being not sharable, exclude content of the second element from the screensharing session.

The details of one or more implementations are set forth in the accompanying drawings and the description below. Other features will be apparent from the description and drawings, and from the claims.

### BRIEF DESCRIPTION OF THE DRAWINGS

FIG. 1 shows a first computing device and a second computing device during a screensharing session according to an implementation.

FIG. 2 is a timing diagram showing messages exchanged between, and actions performed by, the first computing device and the second computing device during the screensharing session.

FIGS. 3A and 3B show examples of images from which content that is not shareable is excluded.

FIGS. 4A and 4B show code for elements with capture values.

FIG. 5 is a block diagram of a computing device.

FIG. 6 is a flowchart of an example method for using capture values of content during a screensharing session, according to an implementation.

Like reference numbers refer to like elements.

### DETAILED DESCRIPTION

During a screensharing session, content presented by a display of a first computing device can be sent to a second computing device for presentation on a display of the second computing device. A technical problem with sending the content presented by the display is that the content, sent as images to the second device, may contain sensitive information, such as financial information, personal information, trade secret information, etc. A technical solution to this technical problem is to provide a capture value for elements in the content that controls information included in the images that are generated for screensharing. The content provider can assign the capture value for the elements in the content. The first computing device can determine capture values of elements that are subject to a screenshare operation. For elements with capture values of sharable, the first computing device can send content to the second computing device and/or screensharing session. For elements with capture values of not shareable, the first computing device can exclude the content from the screensharing session. A technical benefit of this technical solution is protecting sensitive content on an element-by-element basis.

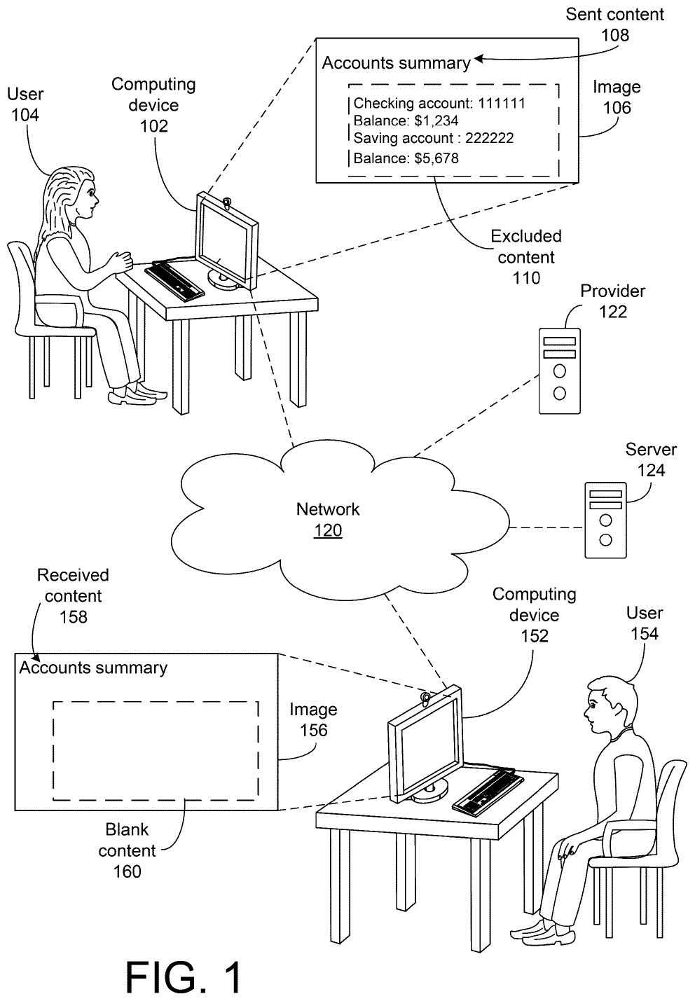

FIG. 1 shows a first computing device 102 and a second computing device 152 during a screensharing session. A first user 104 of the first computing device 102 can establish a screensharing session with a second user 154 of the second computing device 152. The first computing device 102 and the second computing device 152 can communicate with each other via a network 120. The network 120 can include an infrastructure for computing devices to communicate with each other, such as the Internet. In some examples, the first computing device 102 and the second computing device 152 communicate with each other directly on a peer-to-peer basis to facilitate the screensharing session. In some examples, the first computing device 102 and the second computing device 152 communicate with each other via a server 124 that facilitates the screensharing session.

The first computing device 102 can receive content for presentation to the first user 104. The first computing device 102 can receive the content independent of the screensharing session. In some examples, the content is a webpage for rendering and presentation by a browser executing on the first computing device 102. In some examples, the content includes HyperText Markup Language (HTML) content for rendering and presentation by a browser executing on the first computing device 102. The first computing device 102 can receive the content from a provider 122. The provider 122 can provide application content to the first computing device 102. The provider 122 can include, for example, a server that maintains a website and sends the content to the first computing device 102 via the network 120. The application content can include elements, such as HTML elements, for presentation on the display of the first computing device 102. The elements can include attributes. The attributes can have values. One of the attributes can be a capture attribute represented by a capture value. The capture value indicates whether the content is to be shared during a screensharing session. If the capture value is shareable, then the first computing device 102 will share and/or send (provide) the content of the element during the screensharing session. If the capture value is not sharable, then the first computing device 102 will exclude, and/or not send, the content of the element during the screensharing session.

FIG. 1 shows an image 106 representing content presented by the first computing device 102 to the first user 104. The first computing device 102 generates and/or presents the image 106 based on at least two elements. The elements based on which the first computing device 102 generates and/or presents the image 106 can be markup language elements, such as HyperText Markup Language (HTML) elements. The first computing device 102 can generate and/or present sent content 108 based on a first element. The first computing device 102 can generate and/or present excluded content 110 based on a second element. In the example shown in FIG. 1, the excluded content 110 is sensitive content (e.g. financial information) that the content owner deems sensitive content.

The screensharing session can include a screensharing request for the first computing device 102 to share application content with the second computing device 152. In response to the screensharing request, the first computing device 102 can determine capture values of elements, such as the first element and the second element, based on which the image 106 is generated and/or presented to the first user 104. Where the content is in a markup language, the browsing application may determine the capture values of elements.

In the example shown in FIG. 1, the first computing device 102 determines that the capture value of the first element is shareable. Based on the capture value of the first element being shareable, the first computing device 102 sends content of the first element to the screensharing session and/or to the second computing device 152. In the example shown in FIG. 1, the first computing device 102 determines that the capture value of the second element is not shareable. Based on the capture value of the second element being not shareable, the first computing device 102 excludes content of the second element from the screensharing session and/or from the second computing device 152. In some examples, excluding content of an element includes replacing, in content sent to the second computing device 152, the content with blank content, such as an empty rectangle or a rectangle filled with a predetermined color. In some examples, excluding content of an element includes modifying the content sent to the second computing device 152 by removing the content (such as text or images) and replacing the content with predetermined text (such as, “Confidential Information”), such as a browser rendering blocking text in place of the content.

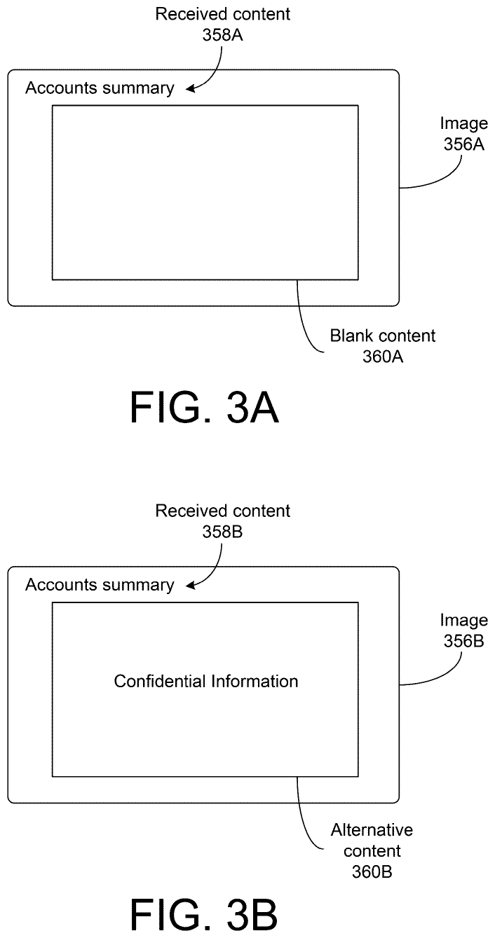

The second computing device 152 generates and/or presents an image 156 to the second user 154 based on content received from the first computing device 102. In the example shown in FIG. 1, the second computing device 152 generates and/or presents, within the image 156, received content 158 based on the content of the first element that the first computing device 102 sent and/or shared. The received content 158 corresponds to the sent content 108. Based on the first computing device 102 not sending and/or sharing the content of the second element based on which the excluded content 110 was generated and/or presented, the second computing device 152 does not generate and/or present content corresponding to the second element. In some examples, the second computing device 152 generates and/or presents blank content 160 in place of the content of the second element. Examples of blank content 160 are shown in FIGS. 3A and 3B.

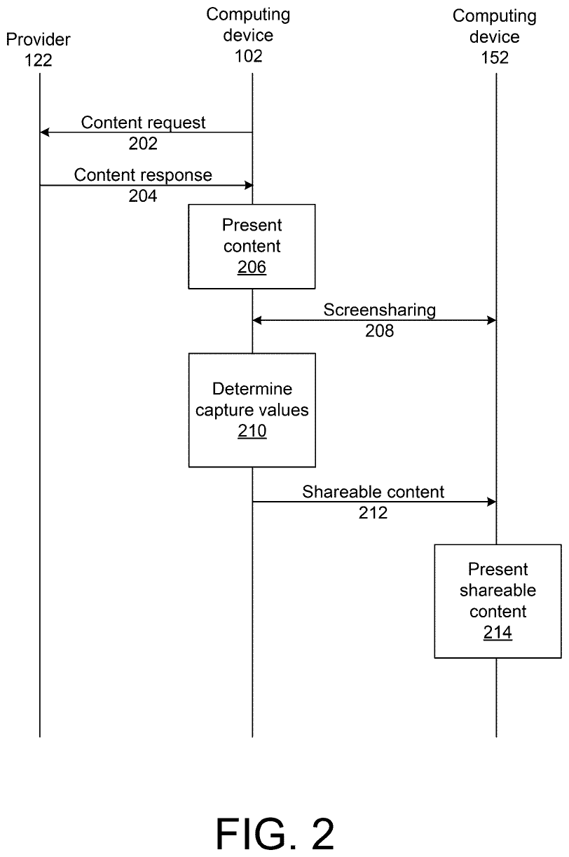

FIG. 2 is a timing diagram showing messages exchanged between, and actions performed by, the first computing device 102 and the second computing device 152 during the screensharing session. The first computing device 102 can send a content request 202 to the provider 122, i.e., the content provider or content owner. The content request 202 can be a markup language request associated with a resource location, such as a Universal Resource Locator (URL). The provider 122 can respond to the content request 202 by sending a content response 204 to the first computing device 102. The content response 204 can include content associated with an element, such as a markup language (e.g., HTML) element. The content response 204 can be a markup language response. In some examples, the content response 204 includes multiple elements, such as elements based on which the first computing device 102 generates and/or presents the sent content 108 and the excluded content 110.

Based on receiving the content response 204, the first computing device 102 can present content (206) to the first user 104. The first computing device 102 can present the content (206) by, for example, generating an image, such as the image 106, and presenting the image on a display included in the first computing device 102.

The first computing device 102 and the second computing device 152 may be engaged in a screensharing session. The screensharing session can include the first computing device 102 sharing screen content with the second computing device 152. Sharing screen content with the second computing device 152 can include sending images and/or content displayed by the display of the first computing device 102 to the second computing device 152.

The first computing device 102 and second computing device 152 can establish a screensharing session 208. In some examples, the screensharing session 208 can include the first computing device 102 determining to send screenshots and/or images presented by a display of the first computing device to the second computing device 152 based on the status and/or existence of the screensharing session. The screensharing session can include the first computing device sharing and/or sending a live video feed to the second computing device 152, with at least a portion of the live video feed including at least a portion of content presented to the first user 104 by the display of the first computing device 102. In some examples, the first computing device 102 can send screenshots and/or images presented by a display of the first computing device to the second computing device 152 in response to the first computing device 102 receiving a screensharing request from the second computing device 152. The screensharing request can be a request for the first computing device 102 to send, to the second computing device 152, images and/or content displayed by the display of the first computing device 102. A browser executing on the first computing device 102 can detect the screensharing request.

The browser executing on the first computing device 102 can, during the screensharing session 208, determine capture values (210) of elements based on which the first computing device 102 generated an image (such as the image 106) and/or presented content. The first computing device 102 can, for example, determine that a capture value of a first element (such as an element based on which the sent content 108 was generated) is shareable and determine that capture value of a second element (such as the element based on which the excluded content 110 was generated) is not shareable. Elements which have a capture value of shareable can be considered shareable content. Elements which have a capture value of not shareable can be considered not shareable content and/or excluded content. Elements which do not have a capture value (i.e. the capture value is not included in the element) can be considered shareable content.

In some examples, the first computing device 102 can provide a warning to the first user 104 relating to an element for which the capture value is not shareable. The first computing device 102 can output an audible alert or a visual message. The first computing device 102 can, for example, highlight or otherwise identify the content for which the capture value is not shareable and request the user of the first computing device 102 to indicate whether the user desires to share the content. The first computing device 102 can then either share the content based on the user indicating a desire to share the content or exclude the content based on the user indicating a desire to not share the content. The user can indicate a desire to either share the content or not share the content by clicking buttons associated with sharing or not sharing the content, providing textual input associated with sharing or not sharing (or “Yes” or “No”), or providing spoken input, as non-limiting examples. In some examples, the user may not be provided with a way to override the capture value of an element. In some examples the user may be provided with a way to override the capture value of some elements and not others. In such implementations, the capture attribute may have a capture value and an override value. The override value may be a binary value that indicates whether the user can override (or not) the capture value.

The first computing device 102 can send the shareable content 212 to the second computing device 152. Elements that have capture values of shareable can be included in the shareable content 212. Elements that have capture values of not shareable can be excluded from the shareable content 212. The shareable content 212 can also include an indication of excluded content. Based on the indication of excluded content in the shareable content 212, the second computing device 152 can present an indication of excluded content, as shown in FIGS. 3A and 3B.

In some examples, a browser setting can determine whether to share content for which the capture value is not shareable. The browser executing on the first computing device 102 can receive input from the user 104 for the browser setting indicating whether to share content for which the capture value is not shareable. If the content has a capture value that is not shareable and the browser setting indicates not to share content for which the capture value is not shareable, then the first computing device will not share the content and/or will exclude the content. If the content has a capture value that is not shareable and the browser setting indicates to share content for which the capture value is not shareable, then the first computing device will share the content.

In response to receiving the shareable content 212, the second computing device 152 can present the shareable content (214). Presenting the shareable content (214) can include generating and/or presenting an image on a display included in the second computing device 152 based on the elements with shareable content that are received from the first computing device 102. The image 156 shown in FIG. 1 is an example of shareable content (214).

FIGS. 3A and 3B show examples of images 356A, 356B from which content that is not shareable is excluded. The images 356A, 356B can be generated by the second computing device 152 based on content, such as shareable content 212, received from the first computing device 102. The images 356A, 356B are examples of the image 156 shown in FIG. 1. Both of images 356A, 356B show received content 358A, 358B. The received content 358A, 358B can be based on an element that the first computing device 102 determined had a capture value of sharable.

In the example of FIG. 3A, the image 356A includes blank content 360A. The blank content 360A can include an empty space or a bounded but otherwise empty box. The blank content 360A can correspond to an element that the first computing device 102 determined had a capture value of not shareable. The blank content 360A can correspond to the excluded content 110 shown in FIG. 1. The second computing device 152 can present the blank content 360A based on the shareable content 212 including the indication of excluded content.

In the example of FIG. 3B, the image 356B includes alternative content 360B. The alternative content 360B includes an image or portion of an image generated and/or presented by the second computing device 152 in lieu of content for which the element had a capture value of not shareable. The content for which the element had a capture value of not shareable has been modified. The alternative content 360B can include text or a symbol indicating that the content was not shared by the first computing device 102. In the example of FIG. 3B, the alternative content 360B includes text, “Confidential Information.” The second computing device 152 can present the alternative content 360B based on the shareable content 212 including the indication of excluded content.

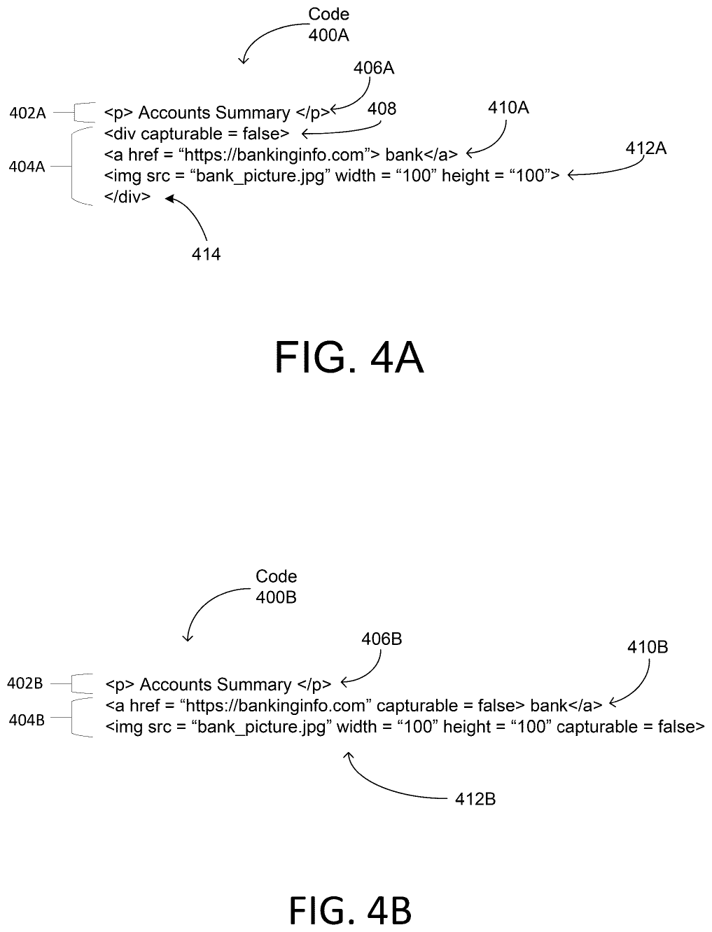

FIGS. 4A and 4B show code for elements with capture values. The code 400A, 400B can guide a computing device (such as the first computing device 102 or second computing device 152) in presenting content for a user to view on a display of the computing device.

The code 400A, 400B can include a first element 402A, 402B that includes shareable content. In the examples shown in FIGS. 4A and 4B, the code 400A, 400B includes a first element 402B. The first element 402A, 402B includes a paragraph 406A, 406B with the text, “Accounts Summary”. The first element 402A, 402B is shareable based on the paragraph 406A, 406B lacking a capturable attribute. In some examples, the paragraphs 406A, 406B explicitly include a capturable attribute with a value of true, and are written as, “<p>Accounts Summary capturable=true</p>”.

In the example of FIG. 4A, the code 400A includes a second element 404A that is sectioned or divided within the code 400A. In the example of FIG. 4A, the second element 404A is sectioned or divided by an opening div tag 408 and a closing div tag 414. In the example of FIG. 4A, the opening div tag 408 includes the capturable attribute with a value of false. The capturable value of false indicates that the second element 404A is not sharable.

The second element 404A can include multiple lines of code. In the example shown in FIG. 4A, the second element 404A includes the opening div tag 408, an address 410A, a source 412A, and the closing div tag 414. The address 410A can specify an address that content generated based on the second element 404A can link to. In some examples, the address 410A is an HTML href attribute that specifies a URL for a link in a page generated based on the second element 404A.

In some examples, the source 412A is a src attribute specifying the image to be displayed. In some examples, source 412A includes a size attribute that specifies a size of the image to be displayed. In some examples, the size attribute includes a width attribute that specifies a width of the image to be displayed and a height attribute that specifies a height of the image to be displayed.

In the example of FIG. 4B, the lines of code within the second element 404B each specify the value of the capturable attribute as false. The second element 404B includes an address 410B with similar features as the address 410A and an additional attribute of a capture value of false and a source 412B with similar features as the source 412A and an additional attribute of a capture value of false.

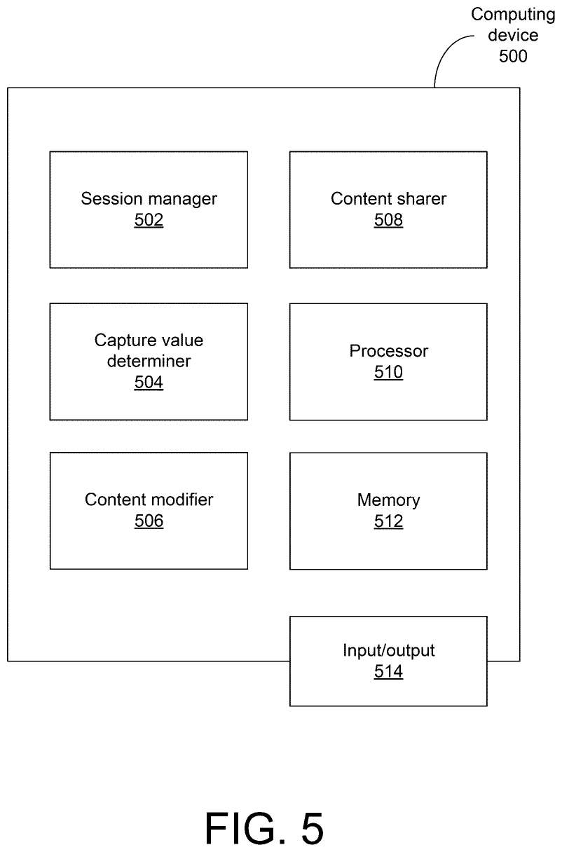

FIG. 5 is a block diagram of a computing device 500. The computing device 500 can determine whether to share or exclude content based on a capture value of an element that includes the content. The computing device 500 is an example of the first computing device 102.

The computing device 500 can include a session manager 502. The session manager 502 can manage a screensharing session with a remote computing device. The session manager 502 can establish a connection and/or session with the remote computing device. The session manager 502 can establish a path for communication with the remote computing device, such as peer-to-peer or via a server (such as the server 124 shown and described with respect to FIG. 1). The session manager 502 can establish a beginning and end of the screensharing session.

The computing device 500 can include a capture value determiner 504. The capture value determiner 504 can determine capture values of elements based on which the computing device 500 is displaying content. The capture value determiner 504 can determine whether the capture values are shareable, indicating that the content of the element can be shared with the remote computing device, or not shareable, indicating that the content of the element should not be shared with the remote computing device. In some examples, the capture value determiner 504 determines the capture value based on an attribute of the element, examples of which is shown and described with respect to FIGS. 4A and 4B. In some examples, the capture value determiner 504 determines the capture value by obtaining the value of the capture value from a tag for the element.

The computing device 500 can include a content modifier 506. In some examples, the content modifier 506 modifies content of elements for which the capture value determiner 504 determines that the content is not shareable. The content modifier 506 can modify the content by replacing the content with predetermined text (such as “Confidential Information” in the example shown in FIG. 3B) or symbols, or replacing the content with a blank image. In some examples, the content modifier 506 modifies the content by obscuring the content. Obscuring the content can include replacing the content with predetermined content such as blank content or blurring the content.

The computing device 500 can include a content sharer 508. The content sharer 508 can share content, such as by sending the shareable content 212 in the example shown and described with respect to FIG. 2, and/or by sending modified content in an example in which the content modifier 506 modifies content that the capture value determiner 504 determines should not be shared.

The computing device 500 can include at least one processor 510. The at least one processor 510 can execute instructions, such as instructions stored in at least one memory device 512, to cause the computing device 500 to perform any combination of methods, functions, and/or techniques described herein.

The computing device 500 can include at least one memory device 512. The at least one memory device 512 can include a non-transitory computer-readable storage medium. The at least one memory device 512 can store data and instructions thereon that, when executed by at least one processor, such as the processor 510, are configured to cause the computing device 500 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing device 500 can be configured to perform, alone, or in combination with another computing device such as or a server in communication with the computing device 500, any combination of methods, functions, and/or techniques described herein.

The computing device 500 may include at least one input/output node 514. The at least one input/output node 514 may receive and/or send data, such as from and/or to, another computer, and/or may receive input and provide output from and to a user such as the user 104. The input and output functions may be combined into a single node, or may be divided into separate input and output nodes. The input/output node 514 can include, for example, a microphone, a camera, an inertial measurement unit (IMU), a display, a speaker, one or more buttons, and/or one or more wired or wireless interfaces for communicating with other computing devices.

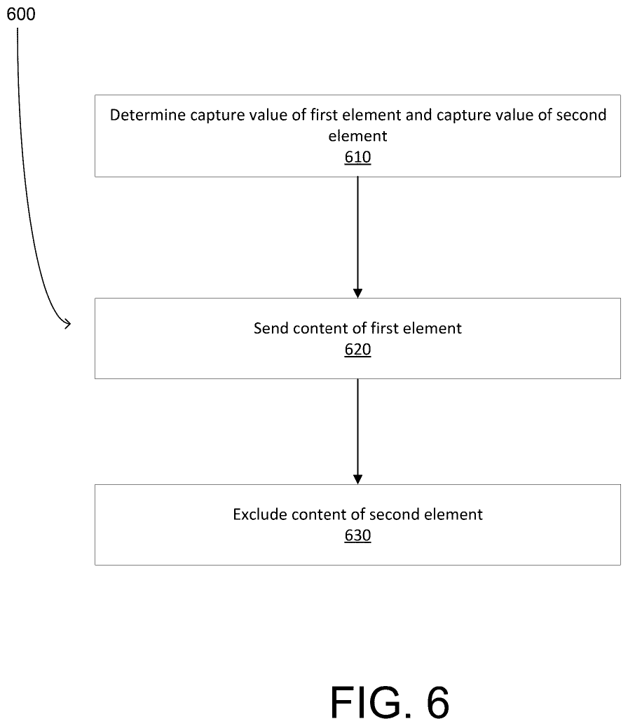

FIG. 6 is a flowchart of an example method 600 for using capture values of content during a screensharing session, according to an implementation. The method 60 can include determining a capture value of a first element and a capture value of a second element (610). Determining the capture value of the first element and the capture value of the second element (610) can include, during a screensharing session, determining the capture value of the first element and the capture value of the second element. The capture value of the first element can be determined by a provider and the capture value of the second element can be determined by the provider. The provider may have provided the first element to the computing device and provided the second element to the computing device. The method 600 can include sending content of the first element (620). Sending content of the first element (620) can include, based on the capture value of the first element being shareable, sending content of the first element to the screensharing session. The method 600 can include excluding content of the second element (630). Excluding content of the second element (630) can include, based on the capture value of the second element being not sharable, excluding content of the second element from the screensharing session.

In some examples, the method 600 is performed by a browser and the provider of the content is a webpage.

In some examples, excluding content of the second element includes the browser modifying a rendering of the content of the second element to obscure the content.

In some examples, excluding content of the second element includes the browser rendering blocking text in place of the content of the second element.

In some examples, the capture value of the second element includes a value of an attribute set by the provider.

In some examples, the value of the attribute is obtained from a tag for the second element.

In some examples, the method further includes, in response to determining that the capture value of the second element is not shareable, displaying a warning relating to the second element.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method performed by a computing device, the method comprising:
during a screensharing session, determining a capture value of a first element and a capture value of a second element, wherein the capture value of the first element is included in code for presenting the first element and the capture value of the second element is included in code for presenting the second element;
based on the capture value of the first element being shareable, sending content of the first element to the screensharing session; and
based on the capture value of the second element being not sharable, excluding content of the second element from the screensharing session.

2. The method of claim 1, wherein the method is performed by a browser and the code is markup language code for rendering a webpage.

3. The method of claim 2, wherein excluding content of the second element includes the browser modifying a rendering of the content of the second element to obscure the content.

4. The method of claim 2, wherein excluding content of the second element includes the browser rendering blocking text in place of the content of the second element.

5. The method of claim 1, wherein the capture value of the second element includes a value of an attribute included in the code.

6. The method of claim 5, wherein the value of the attribute is obtained from a tag for the second element.

7. The method of claim 1, further comprising, in response to determining that the capture value of the second element is not shareable, displaying a warning relating to the second element.

8. A non-transitory computer-readable medium comprising instructions stored thereon that, when executed by at least one processor, are configured to cause a computing device to:
during a screensharing session, determine a capture value of a first element and a capture value of a second element, wherein the capture value of the first element is included in code for presenting the first element and the capture value of the second element is included in code for presenting the second element;
based on the capture value of the first element being shareable, send content of the first element to the screensharing session; and
based on the capture value of the second element being not sharable, exclude content of the second element from the screensharing session.

9. The non-transitory computer-readable medium of claim 8, wherein the code is markup language code for rendering a webpage.

10. The non-transitory computer-readable medium of claim 9, wherein excluding content of the second element includes modifying a rendering of the content of the second element to obscure the content.

11. The non-transitory computer-readable medium of claim 9, wherein excluding content of the second element includes rendering blocking text in place of the content of the second element.

12. The non-transitory computer-readable medium of claim 8, wherein the capture value of the second element includes a value of an attribute included in the code.

13. The non-transitory computer-readable medium of claim 12, wherein the value of the attribute is obtained from a tag for the second element.

14. The non-transitory computer-readable medium of claim 8, wherein the instructions are further configured to cause the computing device to, in response to determining that the capture value of the second element is not shareable, display a warning relating to the second element.

15. A computing device comprising:
at least one processor; and
a non-transitory computer-readable medium comprising instructions stored thereon that, when executed by the at least one processor, are configured to cause the computing device to:
during a screensharing session, determine a capture value of a first element and a capture value of a second element, wherein the capture value of the first element is included in code for presenting the first element and the capture value of the second element is included in code for presenting the second element;
based on the capture value of the first element being shareable, send content of the first element to the screensharing session; and
based on the capture value of the second element being not sharable, exclude content of the second element from the screensharing session.

16. The computing device of claim 15, wherein the code is markup language code for rendering a webpage.

17. The computing device of claim 16, wherein excluding content of the second element includes modifying a rendering of the content of the second element to obscure the content.

18. The computing device of claim 16, wherein excluding content of the second element includes rendering blocking text in place of the content of the second element.

19. The computing device of claim 15, wherein the capture value of the second element includes a value of an attribute included in the code.

20. The computing device of claim 19, wherein the value of the attribute is obtained from a tag for the second element.
